(19) United States
(12) Patent Application Publication
(10) Pub. No.: US 2025/0306817 A1
(43) Pub. Date: Oct. 2, 2025

(54) IMAGE PROCESSING APPARATUS, IMAGE PROCESSING METHOD, AND NON-TRANSITORY COMPUTER READABLE MEDIUM

(71) Applicant: FUJIFILM Business Innovation Corp., Tokyo (JP)

(72) Inventors: Tsutomu NAGAOKA, Kanagawa (JP); Yoshinori Awata, Kanagawa (JP); Junichi Uchiyama, Kanagawa (JP); Hirofumi Sasaki, Kanagawa (JP); Akiyuki Mamiya, Kanagawa (JP)

(73) Assignee: FUJIFILM Business Innovation Corp., Tokyo (JP)

(21) Appl. No.: 18/796,641

(22) Filed: Aug. 7, 2024

(30) Foreign Application Priority Data
Mar. 26, 2024 (JP) 2024-049227

(51) Int. Cl. G06F 3/12

(52) U.S. Cl. CPC G06F 3/1215; G06F 3/1253

(57) ABSTRACT

An image processing apparatus includes a processor that performs an image process configured by a circuit reconfiguration device whose circuit configuration is reconfigurable, the processor being configured to: acquire circuit configuration information on a processing circuit that executes a predetermined processing function; and arrange a processing circuit that executes a processing function required for a print job in a static region and reconfigure plural partial reconfiguration regions into plural split circuits that execute plural processing functions that are selectively available for the print job.

### CROSS-REFERENCE TO RELATED APPLICATIONS

This application is based on and claims priority under 35 USC 119 from Japanese Patent Application No. 2024-049227 filed Mar. 26, 2024.

### BACKGROUND

### (i) Technical Field

The present disclosure relates to an image processing apparatus, an image processing method, and a non-transitory computer readable medium.

### (ii) Related Art

An image processing apparatus including a dynamic portion reconfiguration unit that is capable of reconfiguring an internal circuit configuration dynamically and partially, and a reconfiguration control unit that controls reconfiguration of the circuit configuration by the dynamic portion reconfiguration unit has been known (see Japanese Unexamined Patent Application Publication No. 2015-149025). One or a plurality of processing circuits configured in the dynamic portion reconfiguration unit are each configured to include a data processing unit and a parameter holding unit that holds a parameter used for processing by the data processing unit. A circuit configuration corresponding to a parameter corresponding to a setting in the processing by the data processing unit is defined in the parameter holding unit. The reconfiguration control unit reconfigures only the circuit configuration of the parameter holding unit in accordance with a change of the setting in the processing by the data processing unit.

An information processing apparatus including a processor configured to acquire a plurality of pieces of circuit configuration information corresponding to a plurality of split circuits forming a processing circuit that executes a single processing function, and cause reconfiguration processes that reconfigure a plurality of partial reconfiguration regions into the plurality of split circuits corresponding to the acquired plurality of pieces of circuit configuration information to be executed in parallel, has also been known (see Japanese Unexamined Patent Application Publication No. 2022-59522).

### SUMMARY

Aspects of non-limiting embodiments of the present disclosure relate to improving the processing performance of an image process performed based on a setting of a job option in an image processing apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image processing apparatus including a processor that performs an image process configured by a circuit reconfiguration device whose circuit configuration is reconfigurable, the processor being configured to: acquire circuit configuration information on a processing circuit that executes a predetermined processing function; and arrange a processing circuit that executes a processing function required for a print job in a static region and reconfigure a plurality of partial reconfiguration regions into a plurality of split circuits that execute a plurality of processing functions that are selectively available for the print job.

### BRIEF DESCRIPTION OF THE DRAWINGS

Exemplary embodiments of the present disclosure will be described in detail based on the following figures, wherein:

FIG. 1 is a block diagram illustrating a configuration of an image processing apparatus according to an exemplary embodiment;

FIG. 2 is a block diagram for explaining a configuration that is especially related to partial reconfiguration of an image processing apparatus according to an exemplary embodiment;

FIG. 3 is a diagram for explaining a data configuration of configuration data stored in a file system of an image processing apparatus according to an exemplary embodiment;

FIG. 4 is a flowchart for explaining the flow of a process performed by an image processing apparatus according to an exemplary embodiment; and

FIG. 5 is a diagram illustrating an example of a job property displayed on an operation unit.

### DETAILED DESCRIPTION

Hereinafter, exemplary embodiments of the present disclosure will be described in detail with reference to drawings. The present disclosure is not limited to exemplary embodiments and specific examples described below.

### (1) Entire Configuration of Image Processing Apparatus

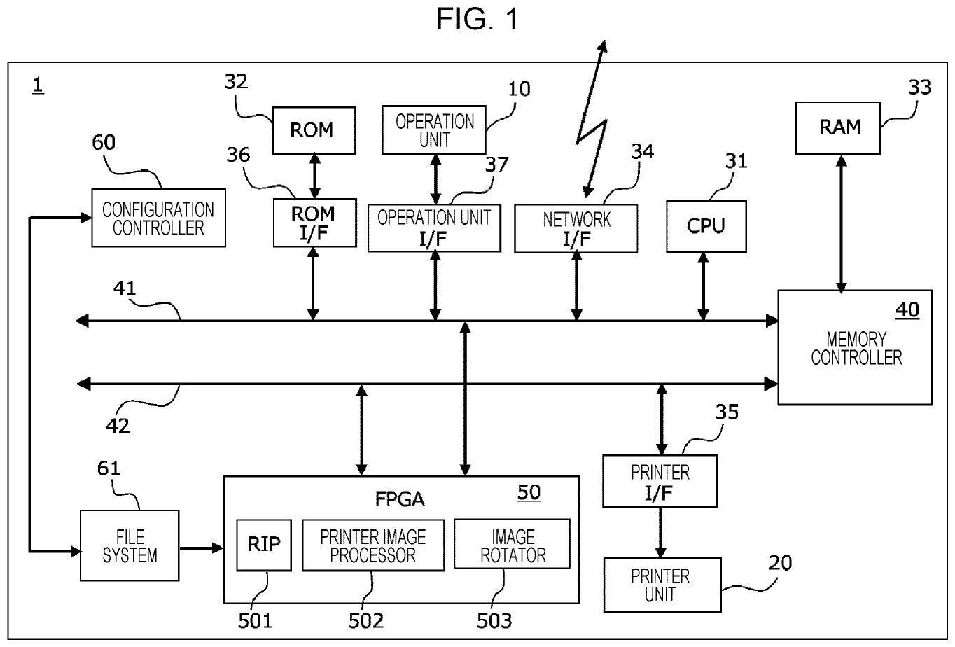

FIG. 1 is a block diagram illustrating a configuration of an image processing apparatus 1 according to an exemplary embodiment.

The image processing apparatus 1 includes an operation unit 10 that is operated by a user and a printer unit 20 that forms an image based on image data on a recording member. For example, an electrophotographic system for electrostatically transferring toner attached to a photosensitive body onto a recording member to form an image, an inkjet system for discharging ink to a recording member to form an image, or the like is used as a method for forming an image on a recording member.

Furthermore, the image processing apparatus 1 includes a central processing unit (CPU) 31 that comprehensively controls an operation of the image processing apparatus 1. The CPU 31 executes a control program for controlling individual units of the image processing apparatus 1. The control program to be executed by the CPU 31 and various data are stored in a read only memory (ROM) 32. A random access memory (RAM) 33 provides a system work memory for operation of the CPU 31 and an image memory for temporarily storing image data. A memory controller 40 controls writing of data onto the RAM 33 and reading of data from the RAM 33. The memory controller 40 is connected to a system bus 41 and an image bus 42 and controls access to the RAM 33.

The image processing apparatus 1 also includes an image processing circuit that performs, regarding a process to be executed by the printer unit 20, an image process such as color correction or gradation correction for a processing target image.

The image processing circuit in this exemplary embodiment is a programmable logic circuit that executes multiple types of image processes while switching between the multiple types of image processes by reconfiguring the circuit. The image processing circuit is, for example, a field programmable gate array (FPGA) 50, which is a reconfigurable integrated circuit.

A raster image processor (RIP) 501 develops page description code contained in a print job received from a host apparatus into a bit map image. A printer image processor 502 performs correction, density adjustment, resolution conversion, and the like for image data to be output (printed) by the printer unit 20. An image rotator 503 is capable of obtaining image data rotated by every 90 degrees. The configuration described above is merely an example of the configuration of functional units of the FPGA 50 at one point in time.

A configuration controller 60 controls the circuit configuration (configuration) of the FPGA 50 under the control of the CPU 31. A file system 61 stores circuit configuration information (configuration data) for configuring the circuit of the FPGA 50. The circuit configuration information on the FPGA 50 is dynamically rewritable and is partially rewritable (partially reconfigurable). That is, while a circuit configured in part of reconfiguration regions of the FPGA 50 is running, another circuit is able to be configured in another part that does not overlap the part occupied by the running circuit.

A network I/F 34 performs communication (transmission and reception) with an external apparatus, which is not illustrated in FIG. 1, on a network. A printer I/F 35 connects the image bus 42 to the printer unit 20 and controls the interface with the printer unit 20.

A ROM I/F 36 controls reading of data, such as a program to be executed by the CPU 31, from the ROM 32. An operation unit I/F 37 controls an interface between the CPU 31 and the operation unit 10. The FPGA 50 and the printer I/F 35 are connected to the image bus 42 for transferring image data to be processed. Furthermore, the network I/F 34, the operation unit I/F 37, the ROM I/F 36, the configuration controller 60, and the FPGA 50 are connected to the CPU 31 with the system bus 41 interposed therebetween. The CPU 31 performs parameter setting for the FPGA 50 and the printer I/F 35 via the system bus 41.

### (2) Partial Reconfiguration

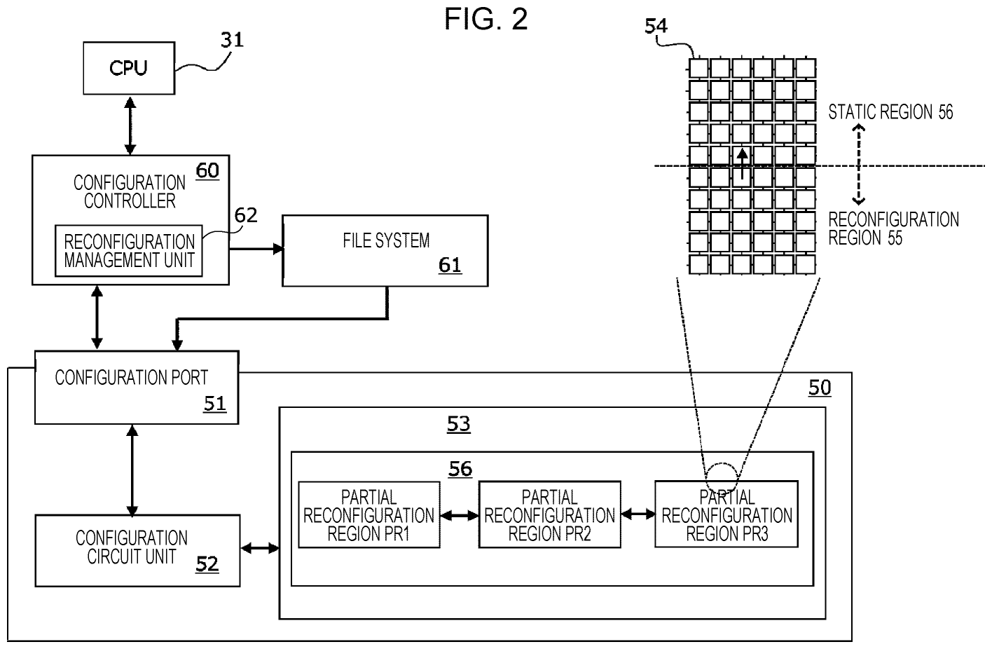

Next, a configuration regarding a partial reconfiguration in the image processing apparatus 1 according to an exemplary embodiment will be described with reference to FIG. 2.

FIG. 2 is a block diagram for explaining a configuration that is especially related to partial reconfiguration of the image processing apparatus 1 according to an exemplary embodiment.

The FPGA 50 includes a configuration port 51 for transferring configuration data. The FPGA 50 also includes a configuration memory 53 in which a logic circuit is configured and a configuration circuit unit 52. The configuration circuit unit 52 analyzes configuration data transmitted from the configuration controller 60 and transfers the configuration data to an appropriate address in the configuration memory 53.

The configuration memory 53 includes a plurality of logic blocks 54 of minimum units whose address is able to be specified. The configuration memory 53 also includes one or more reconfiguration regions 55 in which a reconfiguration image processing function (any one of the RIP 501, the printer image processor 502, and the image rotator 503 in FIG. 1) capable of reconfiguring a set of some logic blocks is able to be configured. The configuration memory 53 also includes a static region 56 containing a clock and clock adjustment logic, an I/O and I/O-related component, and a component particular to FPGA device architecture. The reconfiguration region 55 is connected to the image bus 42 with the I/O-related component, which is configured in the static region 56, interposed therebetween. The reconfiguration region 55 receives control information from the CPU 31 and accesses image data in the RAM 33. When access to image data and a process for the image data are completed, the FPGA 50 generates an interrupt indicating completion of the process (not illustrated in FIG. 2).

### (2.1) Static Region

The static region 56 is a region in which reconfiguration into another circuit is unable to be performed while the image processing apparatus 1 is running, that is, while the power of the FPGA 50 is in the ON state. In the static region 56, a general-purpose circuit that performs the same process even if a circuit reconfigured in the reconfiguration region 55 is changed is provided. In this exemplary embodiment, a processing circuit that executes a processing function required for a print job is arranged in the static region 56.

### (2.2) Reconfiguration Region

The reconfiguration region 55 includes three partial reconfiguration regions (PR1 to PR3: may be simply referred to as “PR” if there is no need to distinguish between them). Each of the partial reconfiguration regions (PR1 to PR3) is able to dynamically reconfigure its circuit configuration. The partial reconfiguration regions (PR1 to PR3) are connected in series with a bus interposed therebetween. The bus width of the bus is twice a bus width required by a plurality of split circuits configured in the static region. Thus, a reduction in the processing speed of an image process executed in each of the partial reconfiguration regions (PR1 to PR3) is suppressed.

In this exemplary embodiment, an example in which a circuit having an image processing function is configured in a partial reconfiguration region PR is described. However, a circuit provided with a function other than the image processing function may be configured in a partial reconfiguration region PR.

The configuration controller 60 writes configuration data stored in the file system 61 into a designated partial reconfiguration region PR in the FPGA 50. The configuration controller 60 includes a reconfiguration management unit 62. The reconfiguration management unit 62 manages each of the partial reconfiguration regions (PR1 to PR3). For example, the reconfiguration management unit 62 manages availability of the partial reconfiguration regions (PR1 to PR3), such as which one of the partial reconfiguration regions (PR1 to PR3) is being used for the current process. Then, the reconfiguration management unit 62 determines whether or not each of the partial reconfiguration regions (PR1 to PR3) is rewritable. In accordance with an instruction from the CPU 31 and a result of the determination as to whether or not each of the partial reconfiguration regions (PR1 to PR3) is rewritable, the reconfiguration management unit 62 rewrites configuration data into a corresponding partial reconfiguration region (PR1 to PR3).

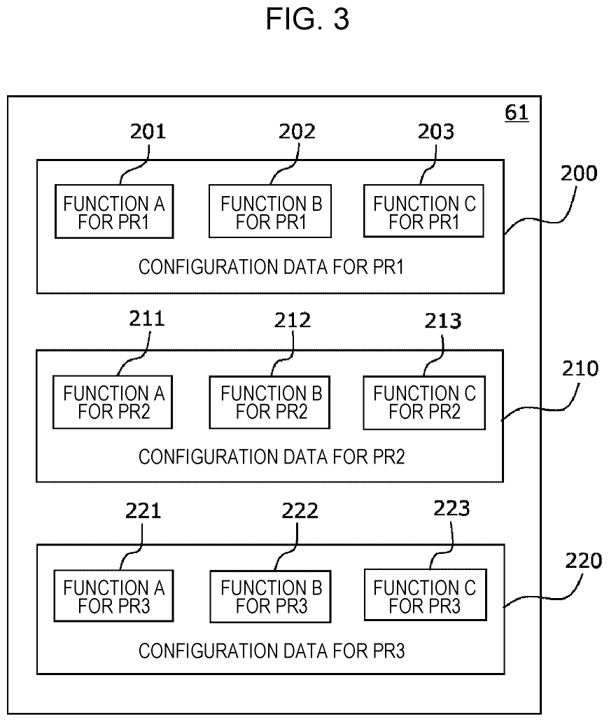

Next, a method for storing configuration data for configuring the partial reconfiguration regions (PR1 to PR3) of the FPGA 50 in the image processing apparatus 1 according to an exemplary embodiment will be described with reference to FIG. 3.

FIG. 3 is a diagram for explaining a data configuration of configuration data stored in the file system 61 in the image processing apparatus 1 according to an exemplary embodiment.

Multiple pieces of configuration data necessary for partial reconfiguration of the partial reconfiguration region PR1 of the FPGA 50 are stored in association with the partial reconfiguration region (PR1). Configuration data 200 for the partial reconfiguration region PR1 represents configuration data for configuring logic circuits in the partial reconfiguration region PR1. In FIG. 3, an example in which three image processing functions (hereinafter, may be simply referred to as functions) A, B, C are able to be configured in the partial reconfiguration region PR1 is illustrated. Configuration data 201 represents a configuration for configuring a circuit for a function A in the partial reconfiguration region PR1. Similarly, configuration data 202 and configuration data 203 represent configurations for configuring circuit configurations for a function B and a function C, respectively, in the partial reconfiguration region PR1.

In this exemplary embodiment, the configuration data 201 to 203 represent configurations for reconfiguring image processing circuits for executing the functions A, B, and C as different image processing functions to be used as additional options for a job.

Configuration data 210 represents configuration data for configuring logic circuits in the partial reconfiguration region PR2. The configuration data 210 for the partial reconfiguration region PR2 also stores configuration data for the three functions A, B, and C. Configuration data 211 represents a configuration for configuring a circuit for the function A in the partial reconfiguration region PR2. Similarly, configuration data 212 and configuration data 213 represent configurations for configuring circuit configurations for the function B and the function C, respectively, in the partial reconfiguration region PR2.

Configuration data 220 represents configuration data for configuring logic circuits in the partial reconfiguration region PR3. The configuration data 220 for the partial reconfiguration region PR3 also stores configuration data for the three image processing functions A, B, and C. Configuration data 221 represents a configuration for configuring a circuit for the function A in the partial reconfiguration region PR3. Similarly, the configuration data 222 and the configuration data 223 represent configurations for configuring circuit configurations for the function B and the function C, respectively, in the partial reconfiguration region PR3.

As described above, configuration data needs to be provided for each of the partial reconfiguration regions (PR1 to PR3). For example, a case where a processing circuit configuration for the function A is configured in each of the partial reconfiguration region PR1 and the partial reconfiguration region PR2 will be considered. In this case, even for the same function A, different pieces of configuration data, such as the configuration data 201 for the function A for the partial reconfiguration region PR1 and the configuration data 211 for the function A for the partial reconfiguration region PR2, need to be provided for individual partial reconfiguration regions.

Thus, if many pieces of configuration data for partial reconfiguration regions (PR1 to PR3) are provided, the partial reconfiguration regions (PR1 to PR3) are able to be used for various image processing functions. However, the volume of data stored in the file system 61 increases. In contrast, if a reconfiguration region to be configured for each function is limited, an image processing function that is able to be configured in each of the partial reconfiguration regions (PR1 to PR3) is limited, and the amount of configuration data is reduced. Thus, the volume of data stored in the file system 61 is reduced.

In this exemplary embodiment, an example in which the FPGA 50 includes three partial reconfiguration regions (PR1 to PR3) and three image processing functions A, B, and C are configured in the partial reconfiguration regions PR is described. The reason that three partial reconfiguration regions are provided and three functions are configured in the partial reconfiguration regions is for the purpose of easier explanation, and the number of partial reconfiguration regions and the number of functions are not limited to three.

### (2.3) Reconfiguration Operation

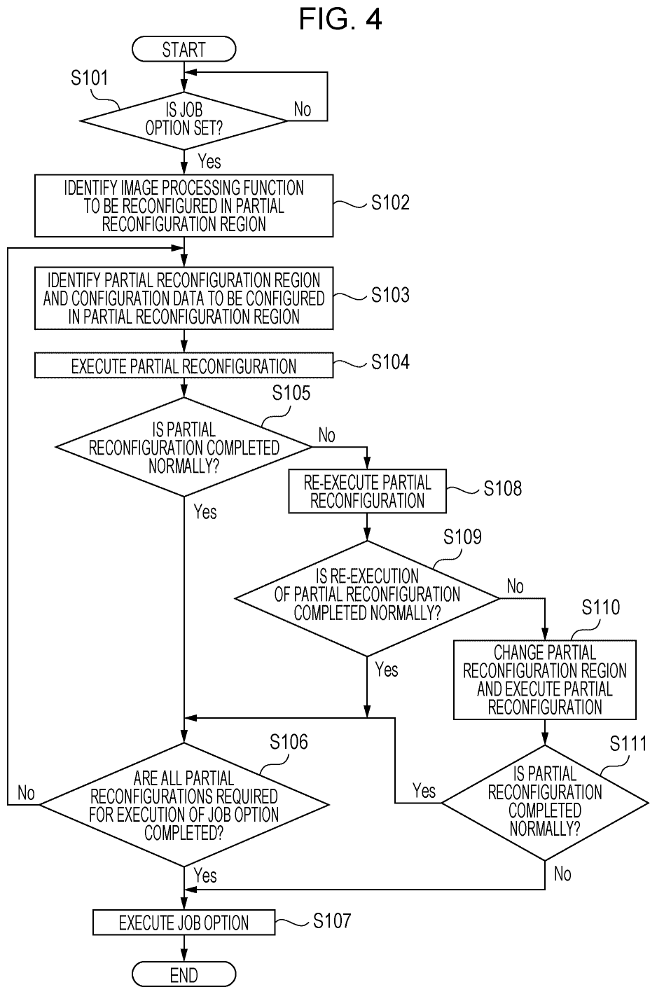

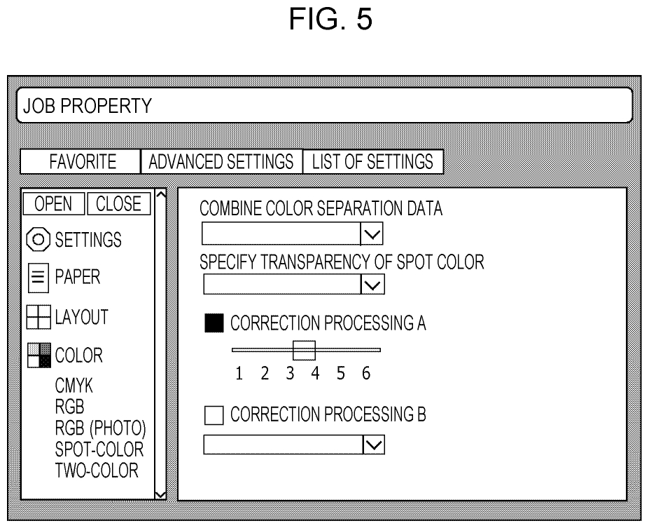

FIG. 4 is a flowchart for explaining the flow of a process performed by the image processing apparatus 1 according to an exemplary embodiment. FIG. 5 is a diagram illustrating an example of a job property displayed on the operation unit 10. Steps in the flowchart of FIG. 4 are performed when the CPU 31 executes the control program stored in the ROM 32.

First, the CPU 31 receives a setting of an additional job option for a print job (S101), and then proceeds to step S102. The CPU 31 identifies an image processing function that is required to be configured in the FPGA 50 for execution of the additional job option (S102). In this exemplary embodiment, in the case where a user has selected (specified) the image processing function A to be used as the additional option from the job property displayed on the operation unit 10 (an example of the job property is illustrated in FIG. 5), the CPU 31 identifies the image processing function A as the function for executing the additional job option.

Next, the CPU 31 identifies a partial reconfiguration region PR to be reconfigured so that the image processing function A identified in step S102 is able to be configured in the partial reconfiguration region PR of the FPGA 50 and configuration data corresponding to the image processing function to be configured in the partial reconfiguration region PR from among multiple pieces of configuration data stored in the file system 61 (S103). For example, in the case where a processing circuit for the image processing function A selected by the user is configured in the partial reconfiguration region PR1, the CPU 31 identifies the configuration data 201 for the image processing function A for the partial reconfiguration region PR1 from among the multiple pieces of configuration data stored in the file system 61. At this time, the CPU 31 identifies, based on information from the reconfiguration management unit 62, a rewritable partial reconfiguration region that is not being used for processing for the job option in the FPGA 50.

Next, the CPU 31 instructs the configuration controller 60 to execute partial reconfiguration (S104). Specifically, the CPU 31 designates the partial reconfiguration region PR that is to be rewritten and the configuration data identified in step S103. For example, the CPU 31 issues an instruction to write the configuration data into the partial reconfiguration region PR1.

The CPU 31 determines, based on a response from the configuration controller 60, whether or not the partial reconfiguration in S104 is completed normally (S105). In this determination, for example, the reconfiguration management unit 62 monitors a signal output from the FPGA 50 and indicating that the partial reconfiguration is completed normally, and it is determined that the partial reconfiguration is completed normally in the case where no error is detected.

In the case where the CPU 31 determines in step S105 that the partial reconfiguration is completed normally (S105: Yes), the CPU 31 proceeds to step S106. The CPU 31 determines whether or not partial reconfiguration for all the image processing functions required for execution of the job option is completed (S106). In the case where partial reconfiguration for all the image processing functions is completed (S106: Yes), the CPU 31 ends this processing and proceeds to step S107. The CPU 31 executes a process for the received job option using the image processing function configured in the FPGA 50 in step S107. Then, the CPU 31 ends the process.

In contrast, in the case where the CPU 31 determines in step S106 that partial reconfiguration for all the image processing functions required for execution of the job option is not completed (S106: No), the CPU 31 returns to step S103 to execute partial reconfiguration for the remaining image processing functions required for execution of the job option.

In contrast, in the case where the CPU 31 determines in step 105 that the partial reconfiguration is not completed normally (S105: No), since the partial reconfiguration executed in step S104 has failed for some reason, the CPU 31 instructs the configuration controller 60 to re-execute the partial reconfiguration executed in step S104 (S108). Then, the CPU 31 proceeds to step S109. The CPU 31 determines whether or not re-execution of the partial reconfiguration executed in step S108 is completed normally (S109). In the case where the CPU 31 determines in step S109 that re-execution of the partial reconfiguration is completed normally (S109: Yes), the CPU 31 proceeds to step S106. In the case where the CPU 31 determines in step S109 that re-execution of the partial reconfiguration is not completed normally (S109: No), the CPU 31 proceeds to step S110.

In step S110, the CPU 31 instructs the configuration controller 60 to switch the partial reconfiguration region PR into which the configuration data for execution of the function is to be written to another partial reconfiguration region PR in which other processes are not being executed. Furthermore, the CPU 31 instructs the configuration controller 60 to write the corresponding configuration data into the switched partial reconfiguration region PR (S110).

In this switching processing, for example, in the case where an attempt to configure a circuit for the image processing function A in the partial reconfiguration region PR1 has failed, if the partial reconfiguration region PR2 is available, the processing circuit for the image processing function A is reconfigured in the partial reconfiguration region PR2. Then, the CPU 31 proceeds to step S111. The CPU 31 determines whether or not the partial reconfiguration in the switched partial reconfiguration region PR executed in step S110 is completed successfully (S111). In the case where the CPU 31 determines in step S111 that the partial reconfiguration is completed normally (S111: Yes), the CPU 31 proceeds to step S106. When the partial reconfiguration terminates with error (S111: No), the CPU 31 ends the processing of partial reconfiguration and proceeds to step S107.

As described above, if writing of configuration data into a partial reconfiguration region PR in the FPGA 50 fails, configuration data for execution of the same function is able to be written into another partial reconfiguration region PR in the FPGA 50. Thus, even if configuration of an image processing function in a partial reconfiguration region PR in the FPGA 50 fails, the same image processing function is able to be configured in another partial reconfiguration region PR.

### (3) Operation of Image Processing Apparatus 1

The image processing apparatus 1 according to an exemplary embodiment includes the FPGA 50, which is a processor configured to perform an image process configured by a circuit reconfiguration device whose circuit configuration is reconfigurable. The FPGA 50 acquires configuration data as circuit configuration information on a processing circuit that executes a predetermined processing function, and arrange a processing circuit that executes a processing function required for a print job in the static region of the FPGA 50 and reconfigure a plurality of partial reconfiguration regions PR into a plurality of split circuits that execute a plurality of processing functions that are selectively available for the print job.

Thus, the processing performance of an image process performed based on a received setting of a job option for the print job is improved.

The plurality of partial reconfiguration regions PR are connected in series with a bus interposed therebetween, and the bus width of the bus is equal to or more than twice a bus width required for the processing circuit arranged in the static region.

Thus, a reduction in the processing speed due to execution of an additional job option is suppressed.

The circuit configuration information on the processing circuit arranged in the static region and a plurality of pieces of circuit configuration information on the plurality of split circuits arranged in the plurality of partial reconfiguration regions are held in a file system of the image processing apparatus and are able to be acquired by the FPGA 50.

Thus, the processing circuit that downloads the circuit configuration information and executes the predetermined processing function is able to be arranged in the static region and the partial reconfiguration region PR.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image processing apparatus comprising:
a processor that performs an image process configured by a circuit reconfiguration device whose circuit configuration is reconfigurable, the processor being configured to:
acquire circuit configuration information on a processing circuit that executes a predetermined processing function; and
arrange a processing circuit that executes a processing function required for a print job in a static region and reconfigure a plurality of partial reconfiguration regions into a plurality of split circuits that execute a plurality of processing functions that are selectively available for the print job.

2. The image processing apparatus according to claim 1, wherein the plurality of partial reconfiguration regions are connected in series with a bus interposed therebetween, and a bus width of the bus is equal to or more than twice a bus width required for the processing circuit arranged in the static region.

3. The image processing apparatus according to claim 1, wherein the circuit configuration information on the processing circuit arranged in the static region and a plurality of pieces of circuit configuration information on the plurality of split circuits arranged in the plurality of partial reconfiguration regions are held in a file system of the image processing apparatus and are able to be acquired by the processor.

4. The image processing apparatus according to claim 2, wherein the circuit configuration information on the processing circuit arranged in the static region and a plurality of pieces of circuit configuration information on the plurality of split circuits arranged in the plurality of partial reconfiguration regions are held in a file system of the image processing apparatus and are able to be acquired by the processor.

5. An image processing method comprising:
acquiring circuit configuration information on a processing circuit that executes a predetermined processing function; and
arranging a processing circuit that executes a processing function required for a print job in a static region and reconfiguring a plurality of partial reconfiguration regions into a plurality of split circuits that execute a plurality of processing functions that are selectively available for the print job.

6. A non-transitory computer readable medium storing a program causing a computer to execute a process comprising:
acquiring circuit configuration information on a processing circuit that executes a predetermined processing function; and
arranging a processing circuit that executes a processing function required for a print job in a static region and reconfiguring a plurality of partial reconfiguration regions into a plurality of split circuits that execute a plurality of processing functions that are selectively available for the print job.
